(19) United States
(12) Patent Application Publication
(10) Pub. No.: US 2026/0328256 A1
(43) Pub. Date: Oct. 22, 2026

(54) SHOCK ABSORBER

(71) Applicant: Hitachi Astemo, Ltd., Ibaraki (JP)

(72) Inventors: Yasuhiro AOKI, Ibaraki (JP); Umi TANABE, Ibaraki (JP); Yosuke INOUE, Ibaraki (JP)

(21) Appl. No.: 19/109,804

(22) PCT Filed: Sep. 5, 2023
(86) PCT No.: PCT/JP2023/032339

§ 371 Date: Mar. 7, 2025

(30) Foreign Application Priority Data
Sep. 29, 2022 (JP) 2022-156052

(51) Int. Cl. F16F 9/348; F16F 9/18; F16F 9/512

(52) U.S. Cl. CPC F16F 9/3488; F16F 9/185; F16F 9/512

(57) ABSTRACT

A shock absorber that includes an inner tube, a piston, a first oil passage, a piston extension-side valve, a second oil passage, and a piston compression-side valve. Then, the shock absorber is configured to cause the piston extension-side valve or the piston compression-side valve, whichever corresponds to a damping force having a higher frequency dependency, to match the other of them that corresponds to a damping force having a lower frequency dependency. To achieve that, for example, the piston extension-side valve or the piston compression-side valve, whichever is set to a higher valve-opening pressure (for example, the piston extension-side valve), is provided with a valve-opening promotion mechanism that aligns a valve-opening timing thereof with a valve-opening timing of the other of them that is set to a lower valve-opening pressure (for example, the piston compression-side valve).

### TECHNICAL FIELD

The present disclosure relates to a shock absorber that reduces a vibration of a vehicle such as an automobile.

### BACKGROUND ART

Vehicles such as four-wheeled automobiles are equipped with shock absorbers (dampers) between the vehicle body (sprung) side and each wheel (unsprung) side. A shock absorber disclosed in PTL 1 includes disk valves provided on the lower surface side and the upper surface side of a piston, respectively. The disk valve on the lower surface side of the piston is opened based on an increase in a differential pressure of an oil chamber on the piston upper surface side from an oil chamber on the piston lower surface side when a rod moves to an extension side. The disk valve on the upper surface side of the piston is opened based on an increase in a differential pressure of the oil chamber on the piston lower surface side from the oil chamber on the piston upper surface side when the rod moves to a compression side.

### CITATION LIST

### Patent Literature

PTL 1: Japanese Patent Application Laid-Open No. 2020-34068

### SUMMARY OF INVENTION

### Technical Problem

Then, when being mounted (implemented or employed) on the vehicle, the shock absorber should be adapted to this vehicle. More specifically, the shock absorber is subjected to an adjustment (tuning) of a damping force thereof so that desired ride comfort can be acquired on the vehicle where this shock absorber is mounted. In this case, the shock absorber is adapted toward the desired ride comfort mainly by adjusting the damping force with respect to the piston speed on the extension side and the compression side. However, just adjusting the damping force with respect to the piston speed on the extension side and the compression side may result in impaired ride comfort depending on the road surface condition and achieve comfortable running only on limited road surfaces.

One of objects of the present invention is to provide a shock absorber capable of acquiring such a damping force characteristic that a sprung side of a vehicle is stabilized regardless of a road surface.

### Solution to Problem

According to the present invention, preferably, a shock absorber includes an inner tube sealingly containing hydraulic fluid therein, a piston slidably provided in the inner tube and partitioning an inside of the inner tube into a first chamber and a second chamber, a first passage provided on the piston, a first valve configured to open and close the first passage, a second passage provided on the piston, and a second valve configured to open and close the second passage. The first valve or the second valve, whichever is set to a higher valve-opening pressure, is provided with a valve-opening promotion mechanism configured to align a valve-opening timing thereof with a valve-opening timing of the other of them that is set to a lower valve-opening pressure.

Further, according to the present invention, preferably, a shock absorber includes an inner tube sealingly containing hydraulic fluid therein, a piston slidably provided in the inner tube and partitioning an inside of the inner tube into a first chamber and a second chamber, a first passage provided on the piston, a first valve configured to open and close the first passage, a second passage provided on the piston, and a second valve configured to open and close the second passage. The shock absorber is configured to cause a frequency characteristic of the first valve or the second valve, whichever corresponds to a damping force having a higher frequency dependency, to match a frequency characteristic of the other of them that corresponds to a damping force having a lower frequency dependency.

Further, according to the present invention, preferably, a shock absorber includes an inner tube sealingly containing hydraulic fluid therein, a piston slidably provided in the inner tube and partitioning an inside of the inner tube into a first chamber and a second chamber, a first passage provided on the piston, a first valve configured to open and close the first passage, a second passage provided on the piston, and a second valve configured to open and close the second passage. The first valve or the second valve, whichever is set to a higher valve-opening pressure, is provided with a low-speed valve subjected to a weaker biasing force compared with the other of them that is set to a lower valve-opening pressure and configured to open the first passage or the second passage when a piston speed is low.

Further, according to the present invention, preferably, a shock absorber includes an inner tube sealingly containing hydraulic fluid therein, a piston slidably provided in the inner tube and partitioning an inside of the inner tube into a first chamber and a second chamber, an outer tube provided outside the inner tube and defining a reservoir chamber between the outer tube and the inner tube, a valve body provided between the reservoir chamber and the second chamber, a first passage provided on the piston, a first valve (for example, a piston extension valve) configured to open and close the first passage, a first orifice provided to the first passage, a second passage provided on the piston, a second valve (for example, a piston compression valve) configured to open and close the second passage, a third passage provided on the valve body, a third valve (for example, a suction valve) configured to open and close the third passage, a fourth passage provided on the valve body, a fourth valve (for example, a body compression valve) configured to open and close the fourth passage, and a second orifice provided to the fourth passage. The first valve or the fourth valve, whichever is set to a higher valve-opening pressure, is provided with a valve-opening promotion mechanism configured to align a valve-opening timing thereof with a valve-opening timing of the other of them that is set to a lower valve-opening pressure (for example, if the valve-opening pressure is the first valve>the fourth valve, the first valve is aligned with the valve-opening timing of the second valve).

According to one aspect of the present invention, a shock absorber can acquire such a damping force characteristic that a sprung side of a vehicle is stabilized regardless of a road surface.

### BRIEF DESCRIPTION OF DRAWINGS

FIG. 1 is a vertical cross-sectional view illustrating a shock absorber according to a first embodiment.

FIG. 2 is an enlarged cross-sectional view illustrating a piston, a first valve, and a second valve in FIG. 1.

FIG. 3 is an enlarged view of a portion labeled (III) in FIG. 2.

FIG. 4 is an exploded perspective view illustrating the piston, the first valve, and the like.

FIG. 5 is a graph of characteristic lines representing the relationship between a piston speed and a damping force at the time of a low-frequency vibration according to the first embodiment.

FIG. 6 is a graph of characteristic lines representing the relationship between an extension/compression ratio (a rebound/bump ratio) of the damping force and a frequency according to the first embodiment.

FIG. 7 is a cross-sectional view at a position similar to FIG. 3 that illustrates a piston, a first valve, and the like according to a modification.

FIG. 8 is a cross-sectional view at a position similar to FIG. 3 that illustrates a piston, a first valve, and the like according to a second embodiment.

FIG. 9 is an exploded perspective view illustrating the piston, the first valve, and the like according to the second embodiment.

FIG. 10 is a graph of characteristic lines representing the relationship between the piston speed and the damping force at the time of a low-frequency vibration according to the second embodiment.

FIG. 11 is a graph of characteristic lines representing the relationship between the extension/compression ratio (the rebound/bump ratio) of the damping force and the frequency according to the second embodiment.

FIG. 12 is a graph of a characteristic line representing the relationship between a damping force in an orifice region and the frequency.

FIG. 13 is a graph of a characteristic line representing the relationship between a damping force in a valve region and the frequency.

FIG. 14 is a graph of characteristic lines representing the relationship between the piston speed and the damping force according to a comparison example.

FIG. 15 is a graph of characteristic lines representing the relationship between the extension/compression ratio (the rebound/bump ratio) of the damping force and the frequency according to the comparison example.

FIG. 16 illustrates hydraulic circuit diagrams of a single tube-type shock absorber (a mono-tube damper) and a double tube-type shock absorber (a twin-tube damper).

FIG. 17 is a diagram for illustrating ride comfort (a vehicle behavior) in an ideal state.

FIG. 18 is a diagram for illustrating ride comfort (a vehicle behavior) desired to be improved.

### DESCRIPTION OF EMBODIMENTS

In the following description, a shock absorber according to an embodiment will be described with reference to the attached drawings citing an example in which it is used for a hydraulic shock absorber built in a vehicle such as a four-wheeled automobile.

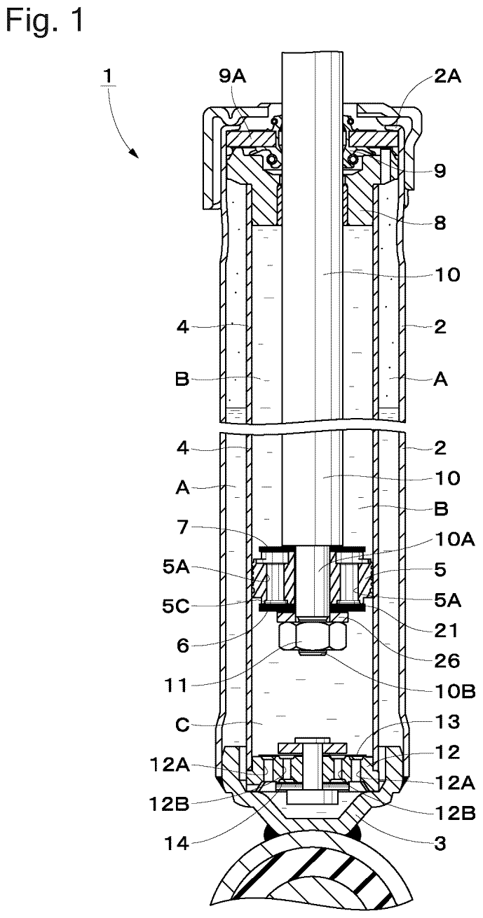

FIGS. 1 to 6 illustrate a first embodiment. In FIG. 1, a shock absorber 1 is, for example, a hydraulic shock absorber for a vehicle such as an automobile. For example, the shock absorber 1 forms a suspension apparatus for the vehicle together with a suspension spring (not illustrated) constituted by a coil spring. In the following description, the shock absorber 1 will be described referring to one axial end side and an opposite axial end side of the shock absorber 1 as a “lower end” side and an “upper end” side, respectively, but the one axial end side and the opposite axial end side of the shock absorber 1 may be the “upper end” side and the “lower end” side, respectively.

The shock absorber 1 includes an outer tube 2, an inner tube 4, a piston 5, a piston rod 10, and a valve body 12. The outer tube 2 is provided outside the inner tube 4. The outer tube 2 is formed into a bottomed tubular shape, and constitutes the outer shell of the shock absorber 1. The lower end side of the outer tube 2, which corresponds to the one end side, is closed by welding a bottom cap 3, and the upper end side of the outer tube 2, which corresponds to the opposite end side, is opened. For example, a plurality of crimped portions 2A is provided on the upper end portion of the outer tube 2. The crimped portions 2A are formed by radially inwardly bending the outer tube 2 by crimping. The opening of the outer tube 2 on the upper end side thereof is closed by a rod guide 8 and a rod seal 9.

The inner tube 4 is disposed coaxially in the outer tube 2. The inner tube 4 forms a double tube-type shock absorber (a cylinder apparatus) together with the outer tube 2. Oil fluid (hydraulic oil) as hydraulic fluid (hydraulic liquid) is sealingly contained in the inner tube 4 and the outer tube 2. The oil fluid as the hydraulic fluid is not limited to oil, and may be, for example, water with an additive mixed therein. The lower end side of the inner tube 4 is fittedly attached to the outer peripheral side of the valve body 12, and the upper end side of the inner tube 4 is closed by the rod guide 8.

The inner tube 4 forms (defines) an annular reservoir chamber A between the inner tube 4 and the outer tube 2. To put it the other way around, the outer tube 2 forms the reservoir chamber A between the outer tube 2 and the inner tube 4. Gas is sealingly contained in the reservoir chamber A together with the oil fluid, which is the hydraulic fluid. For example, this gas may be air in an atmospheric-pressure state or may be compressed nitrogen gas. The reservoir chamber A as a reservoir compensates for entry and exit of the piston rod 10. The valve body 12 is provided between the bottom cap 3 and the inner tube 4 at a position on the lower end side of the inner tube 4.

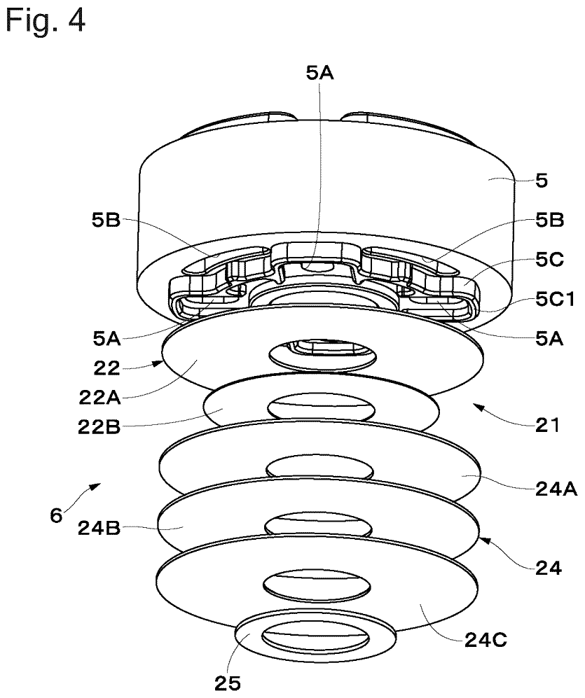

The piston 5 is slidably provided in the inner tube 4. The piston 5 partitions (divides) the inside of the inner tube 4 into two chambers, namely, a rod-side oil chamber B, which corresponds to a first chamber, and a bottom-side oil chamber C, which corresponds to a second chamber. A plurality of oil passages 5A and a plurality of oil passages 5B are provided on the piston 5. The oil passages 5A and 5B can establish communication between the rod-side oil chamber B and the bottom-side oil chamber C. Among the plurality of oil passages 5A and 5B, the first oil passages 5A as a first passage are illustrated in FIGS. 1 to 4, and the second oil passages 5B as a second passage are illustrated in FIG. 4.

The oil passages 5A and 5B form passages that permit a flow of the hydraulic fluid (the oil fluid) directed from one toward the other of the oil chambers B and C in the inner tube 4 according to a movement of the piston 5. In other words, the first oil passages 5A as the first passage and the second oil passages 5B as the second passage establish communication between the rod-side oil chamber B, which corresponds to the first chamber, and the bottom-side oil chamber C, which corresponds to the second chamber, according to a movement of the piston 5. The first oil passages 5A and the second oil passages 5B are flow passages in which a flow of the hydraulic fluid (the oil fluid) is generated according to a movement of the piston 5.

A valve 6 is provided on the piston 5. The valve 6 includes, for example, one or more disk(s) (disk valve(s)). More specifically, the valve 6, which serves as an extension-side (rebound-side) damping valve, is provided on the lower-side surface of the piston 5. The extension-side valve 6 (hereinafter referred to as the piston extension-side valve 6) applies a resisting force to the oil fluid flowing in the first oil passages 5A from the rod-side oil chamber B toward the bottom-side oil chamber C when the piston 5 is slidably displaced upward along the inner tube 4 during an extension stroke (a rebound stroke) of the piston rod 10. By that, a predetermined damping force is generated during the extension stroke of the piston rod 10.

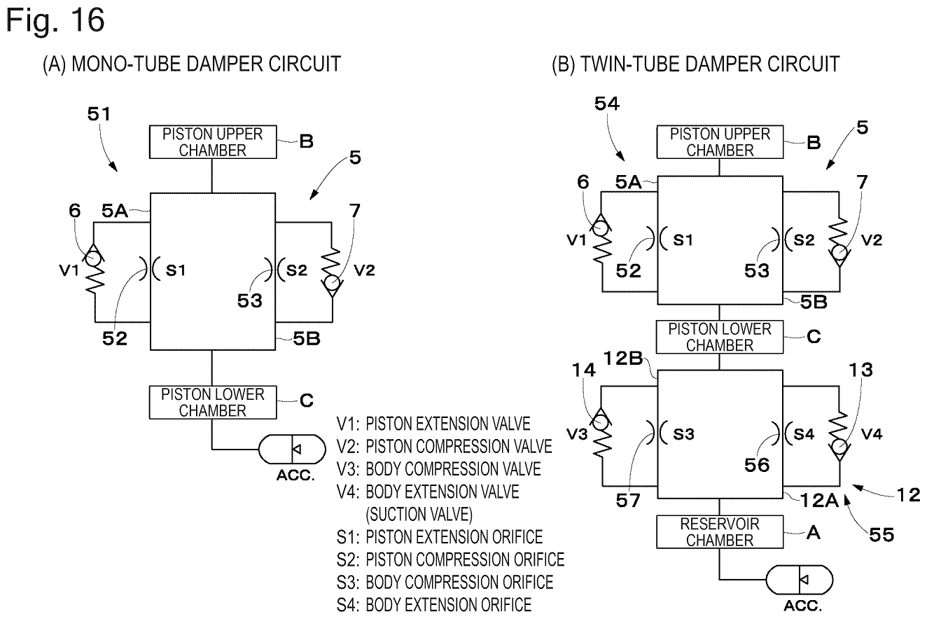

In other words, the piston extension-side valve 6 generates the damping force by controlling the flow of the hydraulic fluid (the oil fluid) that is generated according to a sliding movement of the piston 5 in the inner tube 4. The piston extension-side valve 6 corresponds to a first valve that opens and closes the first oil passages 5A serving as the first passage. As illustrated in FIG. 16, which will be described below, the first oil passage 5A is provided with a piston extension-side orifice 52 that functions as a restriction (an opening) when necessary. The piston extension-side orifice 52, which corresponds to a first orifice, may be provided on the piston extension-side valve 6 or may be provided on the seat side (the piston 5 side).

Besides the piston-side extension valve 6, a valve 7 is provided on the piston 5. The valve 7 includes, for example, one or more disk(s) (disk valve(s)). More specifically, the valve 7, which serves as a compression-side (bump-side) damping valve, is provided on the upper-side surface of the piston 5. The compression-side valve 7 (hereinafter referred to as the piston compression-side valve 7) applies a resisting force to the oil fluid flowing in the second oil passages 5B from the bottom-side oil chamber C toward the rod-side oil chamber B when the piston 5 is slidably displaced downward along the inner tube 4 during a compression stroke (a bump stroke) of the piston rod 10. By that, a predetermined damping force is generated during the compression stroke of the piston rod 10.

In other words, the piston compression-side valve 7 generates the damping force by controlling the flow of the hydraulic fluid (the oil fluid) that is generated according to a sliding movement of the piston 5 in the inner tube 4. The piston compression-side valve 7 corresponds to a second valve that opens and closes the second oil passages 5B serving as the second passage. As illustrated in FIG. 16, which will be described below, the second oil passage 5B is provided with a piston compression-side orifice 53 that functions as a restriction (an opening) when necessary. The piston compression-side orifice 53, which corresponds to a third orifice, may be provided on the piston compression-side valve 7 or may be provided on the seat side (the piston 5 side).

The upper end sides (the opening end sides) of the outer tube 2 and the inner tube 4 are closed by the rod guide 8 and the rod seal 9. The rod guide 8 is a guide member that slidably guides an axial displacement of the piston rod 10. The rod guide 8 is formed as a tubular member having a predetermined shape by applying molding, cutting, or the like on, for example, a metal material or a rigid resin material, and is provided fittedly to the upper end sides (the opening end sides) of the outer tube 2 and the inner tube 4.

The rod seal 9 is provided between the upper surface of the rod guide 8 and the crimped portions 2A of the outer tube 2. The rod seal 9 includes a metallic annular plate 9A as a core metal. An elastic seal material such as rubber is integrally molded on the annular plate 9A by a method such as baking. The rod seal 9 liquid-tightly or air-tightly sealingly separates (seals) between the outer tube 2 and the piston rod 10 with the aid of a sliding contact of the inner periphery of the rod seal 9 with the outer peripheral side of the piston rod 10.

The lower end side of the piston rod 10, which corresponds to the proximal end side, is inserted in the inner tube 4, and the upper end side of the piston rod 10, which corresponds to the distal end side, protrudes out of the inner tube 4 via the rod guide 8. In other words, the piston rod 10 is coupled with the piston 5, and extends out of the inner tube 4. The piston 5, the piston compression-side valve 7, and the piston extension-side valve 6 are attached on the lower end side of the piston rod 10. Therefore, a small-diameter portion 10A, which is smaller in diameter than the other portions, is provided on the lower end side of the piston rod 10. Then, an externally threaded portion 10B is provided at the end portion of the small-diameter portion 10A. A nut 11 for fixing the piston 5, the piston compression-side valve 7, and the piston extension-side valve 6 to the piston rod 10 is threadedly engaged with the externally threaded portion 10B.

The valve body 12, which corresponds to a bottom body, is provided on the lower end side of the inner tube 4 at a position between inner tube 4 and the bottom cap 3. The valve body 12 is provided on the body side (the tube side) of the shock absorber 1. The valve body 12 separates (defines) the reservoir chamber A and the bottom-side oil chamber C between the bottom cap 3 and the inner tube 4. Due to that, the valve body 12 is provided between the reservoir chamber A and the bottom-side oil chamber C. A plurality of oil passages 12A and a plurality of oil passages 12B are provided on the valve body 12. The oil passages 12A and 12B can establish communication between the reservoir chamber A and the bottom-side oil chamber C.

The oil passages 12A and 12B form passages that permit a flow of the hydraulic fluid (the oil fluid) directed from one toward the other of the bottom-side oil chamber C in the inner tube 4 and the reservoir chamber A in the outer tube 2 according to a movement of the piston 5. In other words, the third oil passages 12A as a third passage and the fourth oil passages 12B as a fourth passage establish communication between the bottom-side oil chamber C, which corresponds to the second chamber, and the reservoir chamber A, which corresponds to a third chamber, according to a movement of the piston 5. The oil passages 12A and the oil passages 12B are flow passages in which a flow of the hydraulic fluid (the oil fluid) is generated according to a movement of the piston 5.

A valve 13 is provided on the valve body 12. The valve 13 includes, for example, one or more disk(s) (disk valve(s)). More specifically, the valve 13, which serves as an extension-side damping valve, is provided on the upper-side surface of the valve body 12. The extension-side valve 13 (hereinafter referred to as the body extension-side valve 13) applies a resisting force to the oil fluid flowing in the third oil passages 12A from the reservoir chamber A side toward the bottom-side oil chamber C when the piston 5 is slidably displaced upward during the extension stroke of the piston rod 10.

The body extension-side valve 13 corresponds to a third valve that opens and closes the third oil passages 12A serving as the third passage. As illustrated in FIG. 16, which will be described below, the third oil passage 12A is provided with a body extension-side orifice 56 that functions as a restriction (an opening) when necessary. The body extension-side orifice 56, which corresponds to a fourth orifice, may be provided on the body extension-side valve 13 or may be provided on the seat side (the valve body 12 side).

The body extension-side valve 13, which corresponds to the third valve, can be configured as, for example, a suction valve that mainly functions as a check valve (a one-way valve) and generates almost no damping force. In other words, the body extension-side check valve 13 can be configured as a check valve that is opened when the piston 5 is slidably displaced upward during the extension stroke of the piston rod 10, and otherwise is closed. The body extension-side valve 13 configured as such a check valve permits a flow of the oil fluid in the reservoir chamber A through inside the oil passages 12A toward the bottom-side oil chamber C, and prohibits a flow of the oil fluid in the opposite direction therefrom.

Besides the body extension-side valve 13, a valve 14 is provided on the valve body 12. The valve 14 includes, for example, one or more disk(s) (disk valve(s)). More specifically, the valve 14, which serves as a compression-side damping valve, is provided on the lower surface side of the valve body 12. The compression-side valve 14 (hereinafter referred to as the body compression-side valve 14) applies a resisting force to the oil fluid flowing in the fourth oil passages 12B from the bottom-side oil chamber C toward the reservoir chamber A when the piston 5 is slidably displaced downward during the compression stroke of the piston rod 10.

The body compression-side valve 14 corresponds to a fourth valve that opens and closes the fourth oil passages 12B serving as the fourth passage. As illustrated in FIG. 16, which will be described below, the fourth oil passage 12B is provided with a body compression-side orifice 57 that functions as a restriction (an opening) when necessary. The body compression-side orifice 57, which corresponds to a second orifice, may be provided on the body compression-side valve 14 or may be provided on the seat side (the valve body 12 side).

Then, the vehicle runs at an arbitrary speed on a road surface under various conditions. Therefore, the vehicle body receives various inputs from the road surface. It is desired to maintain ride comfort that gives a sense of stability to a passenger under such various running conditions. Then, a commonly-used hydraulic shock absorber is adapted toward desired ride comfort mainly by adjusting the damping force with respect to the piston speed on the compression side and the extension side. Generally, the damping force is adjusted in this manner based on the characteristic in a relatively large-amplitude and low frequency band.

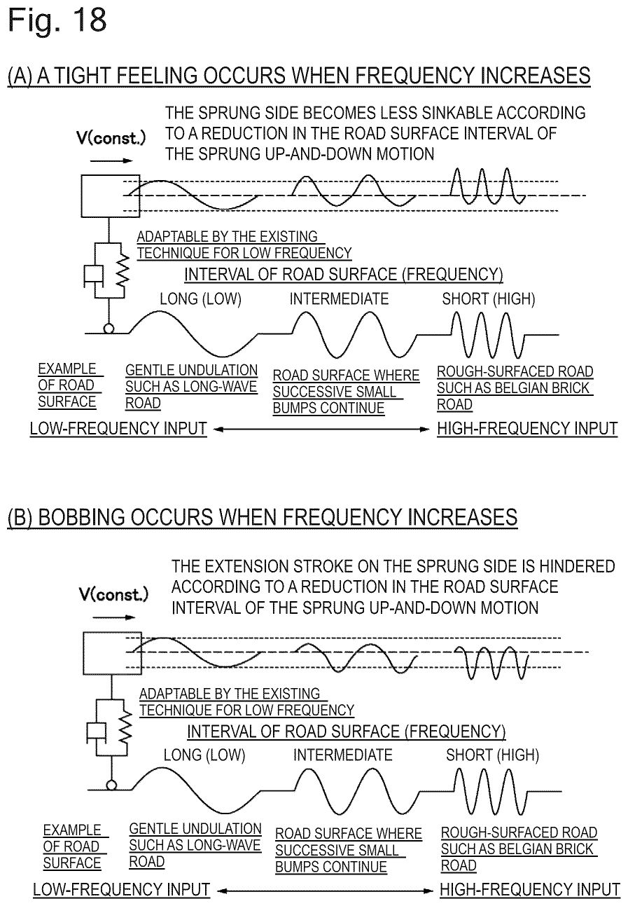

However, the hydraulic damping force exhibits a frequency dependency. Therefore, an appropriate damping force may be unable to be generated by the hydraulic shock absorber when the input frequency undergoes various changes, just by adjusting the magnitude of the damping force with respect to the piston speed on the compression side and the extension side based on the characteristic in a relatively large-amplitude and low frequency band. For example, just adjusting the damping force may lead to occurrence of a tight feeling as illustrated in FIG. 18(A). Alternatively, just adjusting the damping force may lead to occurrence of bobbing as illustrated in FIG. 18(B). As a result, when the vehicle runs actually, an excellent behavior cannot be acquired depending on the road surface, and the stability felt by the passenger may be impaired.

As described above, while running, the vehicle body receives various inputs from the road surface. Further, the size of undulation of the road surface, the bump interval, and the like vary. Therefore, it is important to generate not only a damping force appropriate for the piston speed but also a damping force appropriate for the input frequency. Especially, it is desirable to reduce the frequency dependency of the damping force to acquire stable ride comfort under various running conditions. However, it is difficult to reduce the frequency dependency because, for example, a delay occurs in the damping force due to the compressibility of the hydraulic oil.

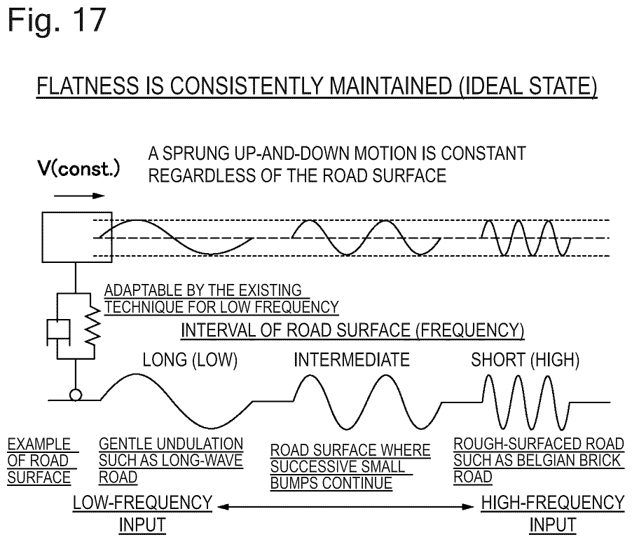

On the other hand, even with the frequency dependency exhibited by each of the extension-side damping force and the compression-side damping force, keeping the ratio therebetween unchanged or little changed with respect to the input frequency can prevent a considerable change made to the balance between up and down motions of the sprung side even when the road surface condition varies. In other words, as illustrated in FIG. 17, a state in which flatness is consistently maintained (an ideal state) can be acquired and an uncomfortable feeling when the vehicle runs can be reduced. Under these circumstances, the embodiment aims to solve the above-described problem by reducing the frequency dependency of the ratio between the extension-side damping force and the compression-side damping force (hereinafter referred to as the “extension/compression ratio of the damping force”).

In the following description, a reason why the extension/compression ratio of the damping force (=the extension-side damping force/the compression-side damping force) has the frequency dependency, and a method for reducing it will be described.

A hydraulic shock absorber that provides a damping force using a common valve stack includes a high pressure-side oil chamber (a high pressure-side chamber) and a low pressure-side oil chamber (a low pressure-side chamber) filled with hydraulic oil. Then, the hydraulic shock absorber includes flow passages through which the hydraulic oil moves between these oil chambers and adjusts the differential pressure based on the areas of these flow passages, thereby acquiring a desired damping force. The flow passages through which the hydraulic oil moves are roughly classified into two types. One of them is an orifice that establishes the communication over a constant area at all times regardless of the differential pressure between the oil chambers. The other is a valve constituted by a valve body formed by stacked disk valves.

The valve blocks the flow passage by being kept closed until the differential pressure generated between the oil chambers upstream and downstream of the flow passage reaches a set pressure. Then, when the differential pressure reaches or exceeds the set pressure, the valve is opened and establishes the communication between the upstream-side oil chamber and the downstream-side oil chamber. Therefore, in a state that the hydraulic shock absorber strokes at a low speed (piston speed), the above-described differential pressure is also low, and thus the valve is closed and the hydraulic oil passes through only the orifice. The differential pressure increases according to a further increase in the piston speed from this state, and the valve is opened when a load derived from this differential pressure exceeds a valve-closing load (a preset) applied to the valve in advance. After that, as the differential pressure increases, the valve lift also increases, and the area of the flow passage is enlarged.

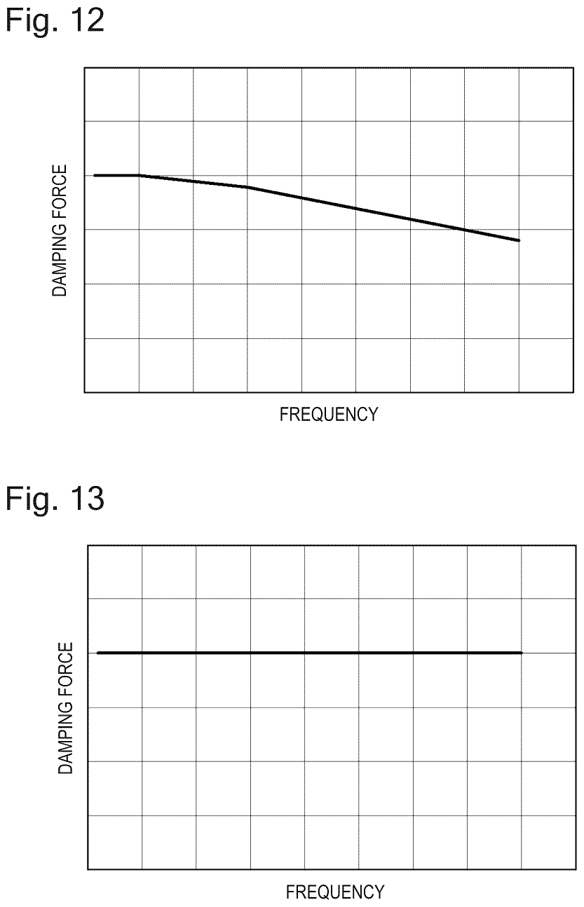

As will be used herein, a region where the differential pressure is generated due to the orifice when the valve is closed is defined to be an “orifice region”, and a region where the valve is opened is defined to be a “valve region”. In this case, the frequency characteristic of the damping force is different between the orifice region and the valve region. More specifically, as illustrated in FIG. 12, in the orifice region, the flow passage area is small and is kept at a constant value, and therefore an increase in the differential pressure is less contributive to acquire a flow amount and is thus likely to be converted into not only an outflow/inflow but also a volume deformation of the hydraulic oil, thereby being accompanied by a large response delay and a reduction in the damping force according to an increase in the frequency. On the other hand, as illustrated in FIG. 13, in the valve region, the response delay can be easily eased, and the damping force hardly varies according to the frequency.

Generally, the damping force characteristic of a damper (a shock absorber) used in an automobile is set to different characteristics on the extension side and the compression side in most cases. To acquire such characteristics, the extension-side valve and the compression-side valve should be set to different valve-opening pressures and different heights of valve openings corresponding to the differential pressure according to the respective stiffnesses and presets, besides the extension side and the compression side being set to different orifice areas. This leads to a difference generated between the valve-opening characteristics of the extension-side and compression-side valves, i.e., the timings at which the valves are opened, thereby bringing about such a state that one of the extension side and the compression side is placed in the orifice region and the other is placed in the valve region depending on the piston speed, causing the frequency dependency of the extension/compression ratio of the damping force due to the above-described difference in the frequency characteristic between the orifice region and the valve region.

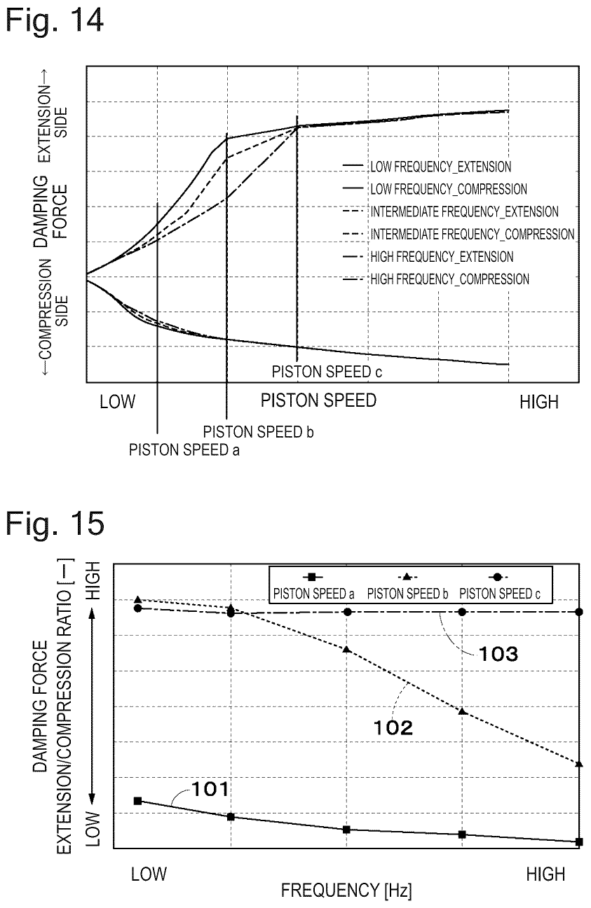

For example, FIG. 14 illustrates an example of the relationship between the piston speed and the damping force when a significantly high valve-opening pressure is applied to the extension-side valve compared with the compression side. In such a case, the extension side maintains the orifice region characteristic until a higher piston speed compared with the compression side, and the extension-side damping force in this region reduces according to an increase in the frequency. On the other hand, the compression side transitions to the valve region at a lower piston speed than the extension side, and therefore the damping force with respect to the frequency less reduces.

Due to such a difference in the characteristic, the frequency dependency emerges in the extension/compression (rebound/bump) ratio of the damping force. FIG. 15 illustrates an example of the relationship between the extension/compression ratio of the damping force (the extension-side damping force/compression-side damping force) and the frequency under a condition similar to FIG. 14, i.e., when a significantly high valve-opening pressure is applied to the extension-side valve compared with the compression side. In this case, a characteristic line 101 in FIG. 15 indicates a change in the extension/compression ratio of the damping force with respect to the frequency at a “piston speed a” in FIG. 14. Similarly, a characteristic line 102 in FIG. 15 indicates a change in the extension/compression ratio of the damping force with respect to the frequency at a “piston speed b” in FIG. 14, and a characteristic line 103 in FIG. 15 indicates a change in the extension/compression ratio of the damping force with respect to the frequency at a “piston speed c” in FIG. 14.

As illustrated in FIG. 15, for example, the extension/compression ratio of the damping force with respect to the frequency more largely changes when the piston speed is the “piston speed b” compared with when the piston speed is the “piston speed a” or the “piston speed b”. In such a case, the sense of stability felt by the passenger is impaired as described above. Therefore, the frequency dependency of the extension/compression ratio can be reduced by causing the respective valves of the extension side and the compression side to be opened at close timings.

However, when a reduction in the speed corresponding to the valve-opening timing on a high damping side (the extension side in the present example) is attempted to allow the extension-side and compression-side valves to be opened at close timings, a common method for stacking disk valves requires a reduction in the stiffness of the valve on the high damping side to lower the valve-opening pressure, and this may result in a reduction in the damping force after the valve is opened and insufficiency of the damping force in an intermediate-to-high speed region, which otherwise should be exerted to, for example, damp a sprung resonance.

In light thereof, according to the embodiment, a valve-opening promotion mechanism (a sub-valve) is provided to the extension-side valve or the compression-side valve, whichever is set to a higher valve-opening pressure. The valve-opening promotion mechanism functions to align this valve with the piston speed at which the valve set to a lower valve-opening pressure is opened. Due to this valve-opening promotion mechanism, the embodiment can cut down the reduction in the valve-opening pressure while lowering the speed corresponding to the valve-opening timing of the valve compared with the common method for stacking disk valves. Accordingly, the embodiment can cut down the reduction in the damping force while reducing the frequency dependency of the extension/compression ratio of the damping force due to the lowered speed corresponding to the valve-opening timing of the valve and the alignment with the valve-opening timing of the valve set to a lower valve-opening pressure.

In other words, due to the provision of the valve-opening promotion mechanism (the sub-valve), the embodiment can shift the valve-opening timing to the low speed side while maintaining the valve-opening pressure of the valve on the extension side or the compression side, whichever is set to a higher valve-opening pressure, thereby aligning the valve-opening timings of the extension side and the compression side while ensuring flexibility of an adjustment of the damping force (of the valve set to a higher valve-opening pressure), thus reducing the frequency dependency of the extension/compression ratio of the damping force. As a result, the shock absorber 1 can realize ride comfort further robust against a change in the road surface condition and sufficient to give a sense of stability to the passenger compared with the conventional technique. In the following description, a configuration for realizing them will be described in detail.

Firstly, a valve targeted for the provision of the valve-opening promotion mechanism will be defined for each of structures of dampers (shock absorbers).

FIG. 16(A) illustrates a hydraulic pressure circuit of a mono-tube damper 51, which is a single-tube shock absorber. As illustrated in FIG. 16(A), the mono-tube damper 51 generates the damping force using the two valves 6 and 7 provided on the piston 5. More specifically, the mono-tube damper 51 includes the piston compression-side valve 7 (the piston compression valve) and the piston extension-side valve 6 (the piston extension valve) provided on the piston 5. In this case, the piston extension-side orifice 52 (the piston extension orifice) and/or the piston compression-side orifice 53 (the piston compression orifice) are/is provided between the rod-side oil chamber B, which corresponds to a piston upper chamber, and the bottom-side oil chamber C, which corresponds to a piston lower chamber, as necessary. In the case of the mono-tube damper 51 configured in this manner, the valve-opening promotion mechanism can be provided to one of the two valves 6 and 7 of the piston 5 that is set to a higher valve-opening pressure (for example, the piston extension-side valve 6).

FIG. 16(B) illustrates a hydraulic pressure circuit of a twin-tube damper 54, which is a double tube-type shock absorber. The shock absorber 1 according to the embodiment corresponds to the twin-tube damper 54. As illustrated in FIG. 16(B), the twin-tube damper 54 includes the four valves 6, 7, 13, and 14 on the piston 5 side and the body 55 side. More specifically, the twin-tube damper 54 includes the piston compression-side valve 7 (the piston compression valve), which contributes to the compression-side damping force, and the piston extension-side valve 6 (the piston extension valve), which contributes to the extension-side damping force, on the piston 5 side. In this case, the piston extension-side orifice 52 (the piston extension orifice) and/or the piston compression-side orifice 53 (the piston compression orifice) are/is provided between the rod-side oil chamber B, which corresponds to the piston upper chamber, and the bottom-side oil chamber C, which corresponds to the piston lower chamber, as necessary.

Further, the twin-tube damper 54 includes the body extension-side valve 13 (the body extension valve), which contributes to the extension-side damping force, and the body compression-side valve 14 (the body compression-valve), which contributes to the compression-side damping force, on the body 55 (the valve body 12) side. In this case, the body extension-side orifice 56 (the body extension orifice) and/or the body compression-side orifice 57 (the body compression orifice) are/is provided between the bottom-side oil chamber C, which corresponds to the piston lower chamber, and the reservoir chamber A, as necessary.

In this example, the attempt to reduce the frequency dependency of the extension/compression ratio of the damping force can be satisfied by aligning the valve-opening timings (the piston speeds) of all of the valves. However, this is not realistic because the stiffness (the valve stiffness) largely varies among these valves. In light thereof, an efficient reduction in the extension/compression ratio of the damping force is attempted mainly by aligning the valve-opening timings of the valves contributive to the generation of the damping force. For this reason, the body extension-side valve 13, which is constituted by a suction valve that mainly functions as a check valve and generates almost no damping force, is ignored because being little contributive to the damping force characteristic, and the valve-opening timings of the remaining three valves 6, 7, and 14 are adjusted according to the following concept.

First, the frequency dependency of the damping force is attributed to a reduction in the responsiveness in the orifice region. Therefore, the frequency dependency noticeably emerges in a valve set to a high valve-opening pressure and maintains the orifice region until a further high piston speed. Accordingly, a valve set to the highest valve-opening pressure among the three valves 6, 7, and 14 is provided with the valve-opening promotion mechanism, and is adjusted to be opened at a timing close to a less stiff valve set to a lower valve-opening pressure. More specifically, the valve-opening pressures are compared between the piston compression-side valve 7 and the body compression-side valve 14, which contribute to the compression-side damping force, and the piston extension-side valve 6, which contributes to the extension-side damping force.

For example, if the extension-side damping force is greater than the compression-side damping force, i.e., the valve-opening pressure of the piston extension-side valve 6 is the highest, the piston extension-side valve 6 is provided with the valve-opening promotion mechanism. This works to make the valve-opening timing of the piston extension-side valve 6 closer to the valve-opening timing of the piston compression-side valve 7 or the body compression-side valve 14 contributive to the compression-side damping force, whichever is set to a lower valve-opening pressure (in principle, the piston compression-side valve 7 is selected from the perspective of the pressure balance relationship). Next, if the compression-side damping force is greater than the extension-side damping force, i.e., the valve-opening pressure of the body compression-side valve 14 is the highest, the body compression-side valve 14 is provided with the valve-opening promotion mechanism. This allows the body compression-side valve 14 to be opened at a timing closer to the valve-opening timing of the piston extension-side valve 6.

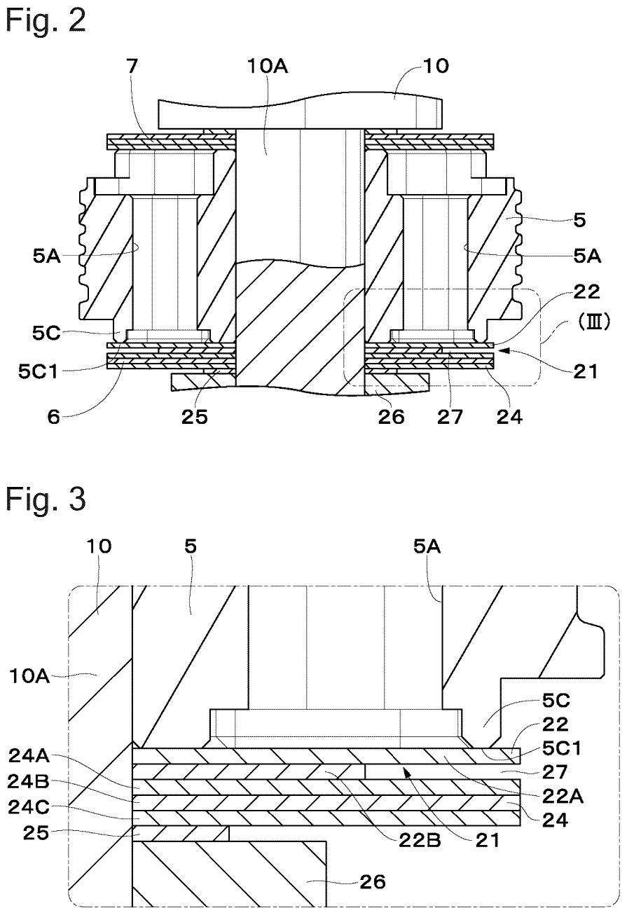

Next, a valve-opening promotion mechanism 21 according to the first embodiment will be described with additional reference to FIGS. 2 to 4 along with FIG. 1. In the first embodiment, the valve-opening promotion mechanism 21 is provided to the piston extension-side valve 6.

The piston extension-side valve 6 includes a low-speed valve 22, and a second-stage valve 24 as a main valve. The valve-opening promotion mechanism 21 is formed by the low-speed valve 22. The low-speed valve 22 includes a low-speed disk 22A, which corresponds to a valve opened at a low speed, and a small-diameter disk 22B, which corresponds to a small-diameter valve. The low-speed disk 22A is in contact with a seat portion 5C provided on the openings of the first oil passages 5A of the piston 5. The low-speed disk 22A is formed as an annular plate with an insertion hole formed on the inner side thereof. The low-speed disk 22A, which constitutes the low-speed valve 22, is seated on and separated from a seat pressure-receiving surface 5C1 of the seat portion 5C. As illustrated in FIG. 4, the seat portion 5C is not annularly formed but is formed into a seat shape having a different diameter. A recessed portion (a space) operable as an orifice can be provided on the seat portion 5C by coining (stamping or pressing) as necessary, although this is omitted in the illustration.

The small-diameter disk 22B is disposed on the back surface side (the lower surface side) of the low-speed disk 22A. The outer diameter dimension of the small-diameter disk 22B is smaller than the outer diameter dimension of the seat portion 5C of the piston 5. The outer diameter dimension of the small-diameter disk 22B is smaller than the low-speed disk 22A. The small-diameter disk 22B is also formed as an annular plate with an insertion hole formed on the inner side thereof. The second-stage valve 24 is disposed on the back surface (the lower surface) of the small-diameter disk 22B. The outer diameter dimension of the second-stage valve 24 is equal to the outer diameter dimension of the low-speed disk 22A of the low-speed valve 22. The second-stage valve 24 is formed by stacking three disks 24A, 24B, and 24C, each of which is formed as an annular plate. A retainer 25 and a washer 26 are disposed on the back surface of the second-stage valve 24. Then, the low-speed valve 22 (the low-speed disk 22A and the small-diameter disk 22B), the second-stage valve 24 (the disks 24A, 24B, and 24C), the retainer 25, and the washer 26 are fastened to the piston rod 10 by a nut 11.

In this manner, in the first embodiment, the small-diameter disk 22B is disposed between the low-speed disk 22A and the second-stage valve 24. Due to that, a space 27 is defined by the small-diameter disk 22B between the low-speed disk 22A and the second-stage valve 24. Therefore, the stiffness of the low-speed valve 22 (the low-speed disk 22A) at the beginning of the valve-opening can be lowered with the aid of this space 27. In other words, the space 27 can promote the valve-opening of the low-speed valve 22 (the low-speed disk 22A) since when the piston speed is further low.

As a result, the valve-stiffness of the piston extension-side valve 6 can be lowered because only the low-speed valve 22 (the low-speed disk 22A) thereof functions as a valve body in the region at the beginning of the valve opening where the piston speed is low.

Further, in the intermediate-to-high speed region where the low-speed valve 22 (the low-speed disk 22A) is in contact with the second-stage valve 24, the second-stage valve 24 also functions as a valve body, and therefore the valve stiffness is raised. The present configuration is characterized by having a characteristic of such non-linear valve stiffness. The stiffness of the low-speed valve 22 is determined mainly based on the plate thickness dimension of the low-speed disk 22A and the outer diameter dimension of the small-diameter disk 22B. Therefore, the two parameters (i.e., the plate thickness dimension of the low-speed disk 22A and the outer diameter dimension of the small-diameter disk 22B) are adjusted in such a manner that the valve-opening timing of the piston extension-side valve 6 (i.e., the valve-opening timing of the low-speed valve 22) matches the desired timing.

The size of the space 27 between the low-speed valve 22 (the low-speed disk 22A) and the second-stage valve 24 controls a timing (the piston speed) at which the low-speed valve 22 (the low-speed disk 22A) contacts the second-stage valve 24. This means that a range where the low-speed valve 22 (the low-speed disk 22A) becomes effective is determined by the size of the space 27 (the gap between the low-speed disk 22A and the second-stage valve 24).

Therefore, the size of the space 27 affects the damping force in the intermediate-to-high speed region. Another factor controlling the damping force in the intermediate-to-high speed region is the stiffness of the second-stage valve 24. Therefore, the stiffness of the second-stage valve 24 is adjusted so as to be able to acquire the desired damping force. The second-stage valve 24 may be structured in such a manner that initial deflection is set to the piston extension-side valve 6. Further, the outer diameter of the second-stage valve 24 may vary on the way. In other words, the outer diameters of the disks 24A, 24B, and 24C constituting the second-stage valve 24 may be different from one another.

In any case, in the first embodiment, the piston extension-side valve 6 is provided with the low-speed valve 22 (the low-speed disk 22A and the small-diameter disk 22B) operable as the valve-opening promotion mechanism 21. The valve-opening promotion mechanism 21 reduces the frequency dependency of the extension/compression ratio of the damping force by causing the frequency characteristic of the damping force generated by the piston extension-side valve 6 and the frequency characteristic of the damping force generated by the piston compression-side valve 7 to match each other. The valve-opening promotion mechanism 21 (the low-speed valve 22) causes the frequency characteristic of the damping force of the piston extension-side valve 6 to match the frequency characteristic of the damping force of the piston compression-side valve 7. In this case, the low-speed valve 22 (the low-speed disk 22A) is opened at a piston speed lower than the piston speed at which the piston compression-side valve 7 is opened. This means that the piston extension-side valve 6 is opened when the piston speed is lower compared with the piston compression-side valve 7. Preferably, the adjustment is made in such a manner that the piston compression-side valve 7 and the piston extension-side valve 6 are set to the same timing.

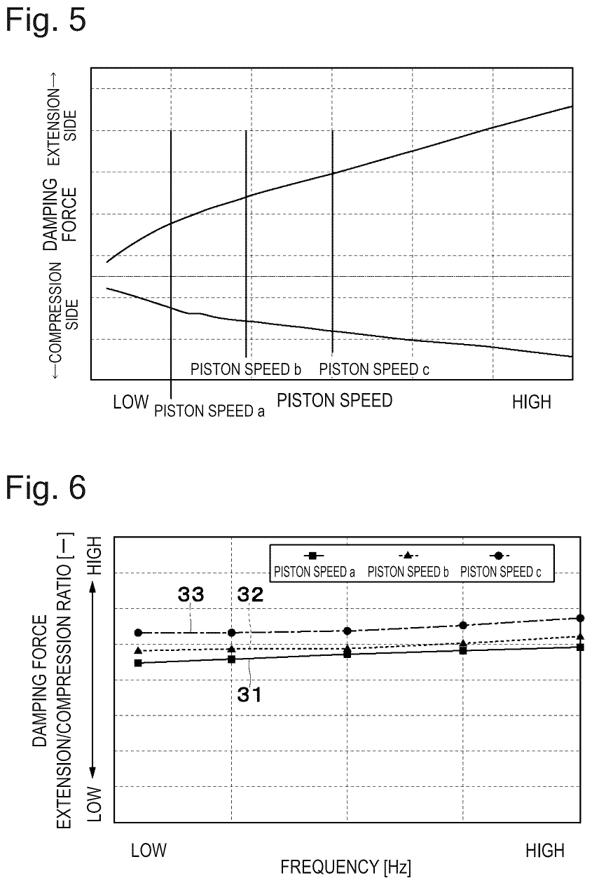

FIG. 5 illustrates the relationship between the piston speed and the damping force of the shock absorber 1 according to the first embodiment, i.e., the characteristic of the damping force with respect to the piston speed at a low frequency in the shock absorber 1 with the valve-opening promotion mechanism 21 provided to the piston extension-side valve 6. FIG. 6 illustrates the relationship between the extension/compression ratio of the damping force and the frequency, i.e., a change in the extension/compression ratio of the damping force with respect to the frequency at each of the three different “piston speed a”, “piston speed b”, and “piston speed c” in FIG. 5. In this case, a characteristic line 31 in FIG. 6 indicates the change in the extension/compression ratio of the damping force with respect to the frequency at the “piston speed a” in FIG. 5. Similarly, a characteristic line 32 in FIG. 6 indicates the change in the extension/compression ratio of the damping force with respect to the frequency at the “piston speed b” in FIG. 5, and a characteristic line 33 in FIG. 15 indicates the change in the extension/compression ratio of the damping force with respect to the frequency at the “piston speed c” in FIG. 5. As clearly seen from a comparison between FIG. 6 and the above-described drawing, FIG. 15, the provision of the valve-opening promotion mechanism 21 can considerably reduce the change in the extension/compression ratio of the damping force with respect to the frequency. As a result, the shock absorber 1 can realize ride comfort highly robust against a change in the road surface condition and sufficient to give a sense of stability to the passenger compared with a configuration not including the valve-opening promotion mechanism 21 (the low-speed valve 22).

In this manner, the shock absorber 1 according to the first embodiment includes the inner tube 4, the piston 5, the first oil passages 5A as the first passage, the piston extension-side valve 6 as the first valve, the second oil passages 5B as the second passage, and the piston compression-side valve 7 as the second valve. Further, the shock absorber 1 includes the outer tube 2 and the valve body 12. Further, the shock absorber 1 includes the piston extension-side orifice 52 (refer to FIG. 16) as the first orifice provided to the first oil passage 5A of the piston 5, the third oil passages 12A as the third passage, the body extension-side valve 13 as the third valve, the fourth oil passages 12B as the fourth passage, the body compression-side valve 14, and the body compression-side orifice 57 (refer to FIG. 16) as the second orifice provided to the fourth oil passage 12B of the valve body 12.

In addition thereto, the shock absorber 1 is configured in such a manner that the frequency characteristic of the piston extension-side valve 6 or the piston compression-side valve 7 (or the body compression-side valve 14), whichever corresponds to a damping force having a higher frequency dependency (for example, the piston extension-side valve 6) matches the frequency characteristic of the other of them that corresponds to a damping force having a lower frequency dependency (for example, the piston compression-side valve 7). To achieve that, the piston extension-side valve 6 or the piston compression-side valve 7, whichever is set to a higher valve-opening pressure (for example, the piston extension-side valve 6), is provided with the valve-opening promotion mechanism 21 that aligns the valve-opening timing thereof with the valve-opening timing of the other of them that is set to a lower valve-opening pressure (for example, the piston compression-side valve 7). Alternatively, the piston extension-side valve 6 or the body compression-side valve 14, whichever is set to a higher valve-opening pressure (for example, the piston extension-side valve 6), is provided with the valve-opening promotion mechanism 21 that aligns the valve-opening timing thereof with the valve-opening timing of the other of them that is set to a lower valve-opening pressure (for example, the piston compression-side valve 7).

In this case, the piston extension-side valve 6 or the piston compression-side valve 7, whichever is set to a higher valve-opening pressure (for example, the piston extension-side valve 6), is opened when the piston speed is lower compared with the other of them that is set to a lower valve-opening pressure (for example, the piston compression-side valve 7). Alternatively, the piston extension-side valve 6 or the body compression-side valve 14, whichever is set to a higher valve-opening pressure (for example, the piston extension-side valve 6), is opened when the piston speed is lower compared with the other of them that is set to a lower valve-opening pressure (for example, the body compression-side valve 14). In other words, the valve-opening promotion mechanism 21 opens the valve set to a higher valve-opening pressure (for example, the piston extension-side valve 6) when the piston speed is lower compared with the valve set to a lower valve-opening pressure (for example, the piston compression-side valve 7 and/or the body compression-side valve 14).

The valve-opening promotion mechanism 21 is formed by, for example, the low-speed valve 22 (the low-speed disk 22A and the small-diameter disk 22B). In other words, the piston extension-side valve 6 or the piston compression-side valve 7, whichever is set to a higher valve-opening pressure (for example, the piston extension-side valve 6), is provided with the low-speed valve 22 subjected to a weaker biasing force (a deformation resisting force, a counter-deformation force, a valve-closing force, or a force for keeping the valve closed) compared with the other of them that is set to a lower valve-opening pressure (for example, the piston compression-side valve 7 and/or the body compression-side valve 14). For example, in the case where the piston extension-side valve 6 is provided with the low-speed valve 22, the low-speed valve 22 opens the first oil passages 5A when the piston speed is low. For example, in the case where the piston compression-side valve 7 is provided with the low-speed valve 22, the low-speed valve 22 opens the second oil passages 5B when the piston speed is low. As illustrated in FIGS. 2 and 3, the space 27 is defined between the low-speed valve 22 and the valve stacked on this low-speed valve 22 (i.e., the second-stage valve 24).

The shock absorber 1 according to the first embodiment is configured in the above-described manner, and an operation thereof will be described next.

The shock absorber 1 is mounted in such a manner that, for example, the distal end side (the upper end side) of the piston rod 10 is attached to the vehicle body side of the vehicle (the automobile), and the bottom cap 3 side located on the proximal end side (the lower end side) of the outer tube 2 is attached to the wheel side (the axle side) of the vehicle. Due to that, when a vibration occurs while the vehicle runs, the shock absorber 1 damps the vibration at this time by generating the damping force using, for example, the valves 6 and 7 of the piston 5 while extending/compressing the piston rod 10.

More specifically, the inside of the bottom-side oil chamber C is placed in a higher-pressure state than the rod-side oil chamber B when the piston rod 10 is in the compression stroke. Then, the oil fluid (the hydraulic oil) in the bottom-side oil chamber C flows into the rod-side oil chamber B via the second oil passages 5B of the piston 5 and the piston compression-side valve 7, thereby generating the damping force. At this time, the oil fluid flows from the bottom-side oil chamber C into the reservoir chamber A via the fourth oil passages 12B of the valve boy 12 and the body compression-side valve 14 by an amount corresponding to the volume of the entry of the piston rod 10 into the inner tube 4. The internally sealingly contained gas is compressed in the reservoir chamber A, and the amount corresponding to the volume of the entry of the piston rod 10 is absorbed.

On the other hand, the inside of the rod-side oil chamber B is placed in a higher-pressure state than the bottom-side oil chamber C when the piston rod 10 is in the extension stroke. Then, the oil fluid (the hydraulic oil) in the rod-side oil chamber B flows into the bottom-side oil chamber C via the first oil passages 5A of the piston 5 and the piston extension-side valve 6, thereby generating the damping force. At this time, the oil fluid flows from inside the reservoir chamber A into the bottom-side oil chamber C via the third oil passages 12A of the valve boy 12 and the body extension-side valve 13 (the check valve) by an amount corresponding to the exit volume (the retraction volume) of the piston rod 10 that exits (retracts from) the inner tube 4.

Then, according to the first embodiment, the piston extension-side valve 6, which is one of the piston extension-side valve 6 and the piston compression-side valve 7 that includes the second-stage valve 24, which is the valve set to a higher valve-opening pressure, is provided with the valve-opening promotion mechanism 21 that aligns the valve-opening timing thereof with the valve-opening timing of the piston compression-side valve 7, which is the other of them that is set to a lower valve-opening pressure. This makes it possible to, for example, raise the stiffness with the piston speed further increased due to the second-stage valve 24 while allowing the low-speed valve 22 of the piston extension-side valve 6 to be opened at a lower piston speed (compared with the conventional configuration not including the valve-opening promotion mechanism 21). Due to that, the shock absorber 1 can secure the damping force in the intermediate-to-high speed region on the extension side while reducing the frequency dependency of the extension/compression ratio of the damping force. As a result, the shock absorber 1 can realize ride comfort further robust against a change in the road surface condition and sufficient to give a sense of stability to the passenger compared with the conventional technique (the configuration not including the valve-opening promotion mechanism 21). In sum, the shock absorber 1 can acquire such a damping force characteristic that the sprung side of the vehicle is stabilized regardless of the road surface, thereby allowing the passenger to continue riding on the vehicle without feeling uncomfortable.

According to the first embodiment, the piston extension-side valve 6 is configured in such a manner that the frequency dependency of the damping force thereof matches the piston compression-side valve 7. In other words, the piston extension-side valve 6, which is the valve corresponding to a damping force having a higher frequency dependency, is configured to match the piston compression-side valve 7, which is the valve corresponding to a damping force having a lower frequency dependency. Due to that, the shock absorber 1 can reduce the frequency dependency of the extension/compression ratio of the damping force. As a result, the shock absorber 1 can realize ride comfort further robust against a change in the road surface condition and sufficient to give a sense of stability to the passenger. In sum, the shock absorber 1 can acquire such a damping force characteristic that the sprung side of the vehicle is stabilized regardless of the road surface, thereby allowing the passenger to continue riding on the vehicle without feeling uncomfortable.

According to the first embodiment, the piston extension-side valve 6, which is the valve set to a higher valve-opening pressure, is opened when the piston speed is lower compared with the piston compression-side valve 7, which is the valve set to a lower valve-opening pressure. Due to that, the shock absorber 1 can acquire a high differential pressure by raising the valve stiffness in the intermediate-to-high region while allowing the piston extension-side valve 6 to be opened at a low piston speed, thereby succeeding in reducing the frequency dependency of the extension/compression ratio of the damping force by causing the piston extension-side valve 6 to be opened at a low piston speed while cutting down a reduction in the damping force of the piston extension-side valve 6.

According to the first embodiment, the piston extension-side valve 6 is provided with the low-speed valve 22, which is subjected to a weaker biasing force compared with the piston compression-side valve 7 and opens the first oil passages 5A when the piston speed is low. Therefore, the shock absorber 1 allows the characteristic at the beginning of the valve-opening of the piston extension-side valve 6 and the stiffness thereof in the intermediate-to-high region to be adjusted independently of each other, thereby succeeding in ensuring the flexibility of the adjustment of the extension-side damping force while reducing the frequency dependency of the extension/compression ratio of the damping force.

According to the first embodiment, the space 27 is defined between the low-speed valve 22 (the low-speed disk 22A) and the second-stage valve 24. This makes the low-speed valve 22 (the low-speed disk 22A) easily displaceable (deformable) to the space 27 side. As a result, the low-speed valve 22 can be opened when the piston speed is low.

According to the first embodiment, the piston extension-side valve 6, which is one of the piston extension-side valve 6 and the body compression-side valve 14 that is set to a higher valve-opening pressure, is provided with the valve-opening promotion mechanism 21 that aligns the valve-opening timing thereof with the valve-opening timing of the piston compression-side valve 7, which is the other of them that is set to a lower valve-opening pressure. This makes it possible to raise the stiffness in the intermediate-to-high speed region while allowing the piston extension-side valve 6 to be opened at a low piston speed. Due to that, the shock absorber 1 can secure the damping force in the intermediate-to-high speed region on the extension side while reducing the frequency dependency of the extension/compression ratio of the damping force. As a result, the shock absorber 1 can realize ride comfort further robust against a change in the road surface condition and sufficient to give a sense of stability to the passenger compared with the conventional technique (the configuration not including the valve-opening promotion mechanism 21). In sum, the shock absorber 1 can acquire such a damping force characteristic that the sprung side of the vehicle is stabilized regardless of the road surface, thereby allowing the passenger to continue riding on the vehicle without feeling uncomfortable.

The low-speed valve 22 according to the first embodiment defines the space 27 between the low-speed disk 22A and the second-stage valve 24, the size of which is determined based on the plate thickness of the small-diameter disk 22B. Then, a reduction in the space 27 between the small-diameter disk 22B and the second-stage valve 24 allows the piston extension-side valve 6 to transition to a region where the valve stiffness is high at an earlier timing (piston speed), thereby leading to generation of a great damping force. However, the plate thickness of the small-diameter disk 22B is difficult to be reduced by a predetermined or more thickness from the viewpoint of mass productivity and strength, and may constitute a constraint on the flexibility of the generation of the damping force.

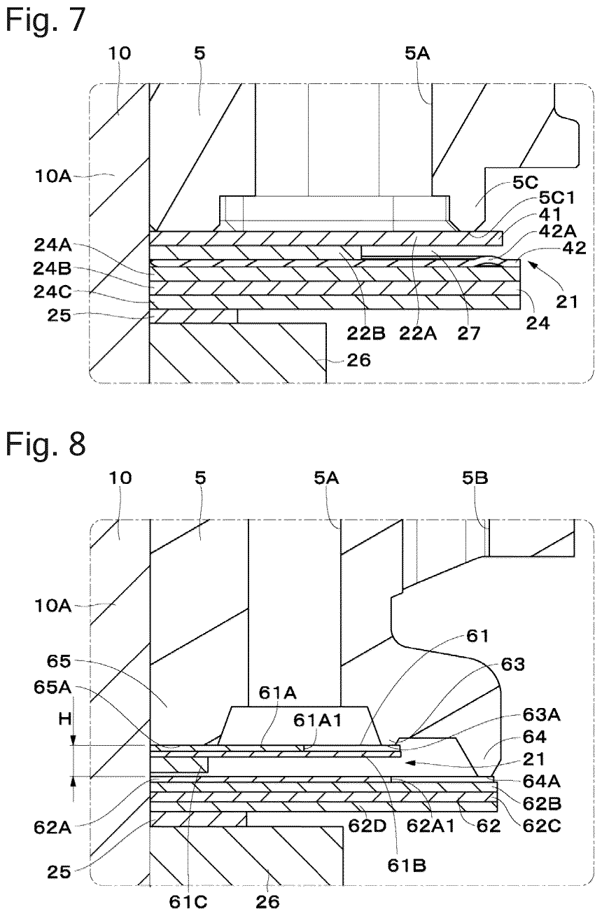

In light thereof, in a modification illustrated in FIG. 7, a space adjustment disk 42 is provided to a low-speed valve 41 between the small-diameter disk 22B and the second-stage valve 24. The space adjustment disk 42 serves to change the size of the space 27 between the radially inner side and the radially outer side. Then, the size of the space 27 is widened on the radially inner portion side and narrowed on the radially outer portion side with the aid of the space adjustment disk 42. In other words, in the modification, the low-speed valve 41 includes the space adjustment disk 42 as a fifth valve (a space adjustment valve) and the small-diameter disk 22B. The space adjustment disk 42 includes a protrusion portion 42A that protrudes toward the low-speed disk 22A of the piston extension-side valve 6 and is axially wider than the other portions. The small-diameter disk 22B is provided between the low-speed disk 22A of the piston extension-side valve 6 and the space adjustment disk 42. The small-diameter disk 22B is smaller in diameter than the low-speed disk 22A and the space adjustment disk 42.

In this manner, in the modification, the space adjustment disk 42, whose thickness changes on the radially outer side, is provided between the small-diameter disk 22B and the second-stage valve 24. This allows the space 27 to be set to a small size between the low-speed disk 22A and the second-stage valve 24 even when the plate thickness of the small-diameter disk 22B is thickened. As a result, the modification can improve the flexibility of the generation of the damping force while allowing the plate thickness of the small-diameter disk 22B to be set to a thickness sufficient to ensure the mass productivity and the strength.

In sum, the low-speed valve 41 according to the modification includes the space adjustment disk 42 in addition to the low-speed disk 22A and the small-diameter disk 22B. Then, the space adjustment disk 42 includes the protrusion portion 42A protruding toward the low-speed disk 22A. This makes it possible to narrow the space 27 between the low-speed disk 22A of the piston extension-side valve 6 and the space adjustment disk 42 (the protrusion portion 42A) while increasing the plate thickness of the small-diameter portion 22B. As a result, the modification can both “ensure the mass productivity and the strength of the small-diameter disk 22B” and “ensure the flexibility of the adjustment of the damping force of the piston extension-side valve 6” at the same time.

The modification has been described citing the example in which the space adjustment disk 42 is configured to include the protrusion portion 42A. However, without being limited thereto, the space adjustment disk may, for example, have a plate thickness different between the radially inner portion and the radially outer portion. In other words, the space adjustment disk may be formed in such a manner that the plate thickness of the radially outer portion is thicker than the plate thickness of the radially inner portion. Further, the protrusion portion may be formed integrally with the disk by pressing, or may be formed integrally with the disk by melting and attaching a member different from the disk to a portion corresponding to the protrusion portion by welding.

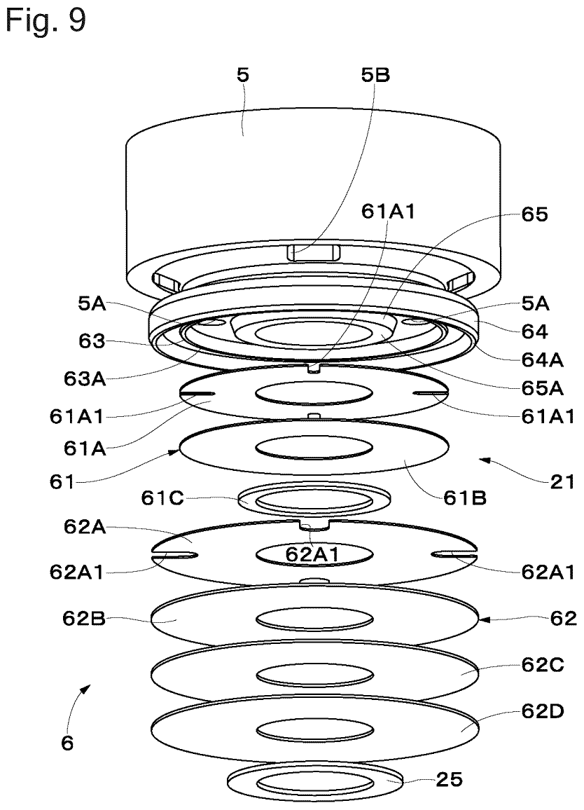

Next, FIGS. 8 to 11 illustrate a second embodiment. The second embodiment is characterized by being configured to include a first seat portion, which the low-speed valve is seated on and separated from, and a second seat portion, which the main valve (the second-stage valve) is seated on and separated from. The second embodiment will be described, indicating similar components to the above-described first embodiment by the same reference numerals and omitting descriptions thereof.

In the second embodiment, the piston extension-side valve 6 includes a low-speed valve 61 and a second-stage valve 62 as the main valve. The valve-opening promotion mechanism 21 is formed by the low-speed valve 61. In other words, the piston extension-side valve 6 includes the low-speed valve 61, which is set to a low valve stiffness and opened at a low speed to thus contribute to the damping force in the low speed region, and the second-stage valve 62, which is set to a higher stiffness compared with the low-speed valve 61 and contributes to the damping force in the intermediate-to-high speed region. The low-speed valve 61 and the second-stage valve 62 are arranged in series in the hydraulic pressure circuit.

The low-speed valve 61 includes two low-speed disks 61A and 61B, and a retainer 61C. The second-stage valve 62 includes four disks 62A, 62B, 62C, and 62D. The retainer 61C is provided between the low-speed disk 61B disposed on the back surface side (the lower surface side) and the disk 62A of the second-stage valve 62. In the second embodiment, the low-speed valve 61 and the second-stage valve 62 are seated on and separated from different seat portions 63 and 64, respectively. More specifically, the piston 5 includes the inner seat portion 63 as a first seat portion which the low-speed valve 61 is seated on and separated from, and the outer seat portion 64 as a second seat portion located on the radially outer side of the inner seat portion 63, which the second-stage valve 62 is seated on and separated from. The inner seat portion 63, which the low-speed valve 61 contacts, is disposed on the radially inner side of the outer seat portion 64, which the second-stage valve 62 contacts. Both the inner seat portion 63 and the outer seat portion 64 have annular seat shapes.

The low-speed valve 61 is provided for the purpose of allowing the piston extension-side valve 6 to be opened starting from a further low speed region. Therefore, it is desirable that the height between a “seat surface 63A of the inner seat portion 63 which the low-speed valve 61 is seated on and separated from” and a “support surface 65A of a support portion 65 which the radially inner side of the low-speed valve 61 is in abutment with”, i.e., a step (a difference in height) between the seat surface 63A and the support surface 65A is as short as a variation due to manufacturing allows. Further, the support surface 65A, which the radially inner side of the low-speed valve 61 is in abutment with, is also used as a portion that supports the radially inner side of the second-stage valve 62. In other words, on the support surface 65A, the low-speed valve 61 is stacked first and then the second-stage valve 62 is disposed on the back surface side of this low-speed valve 61. Due to that, a step H, which is the difference in height, is defined between the support surface 65A and a seat surface 64A of the outer seat portion 64.

Further, a preset (a preload or a preset load) may be applied to the second-stage valve 62. In this case, the size of the step H between the support surface 65A and the seat surface 64A of the outer seat portion 64 is set to a size equal to or greater than the thickness of the low-speed valve 61 (the two low-speed disks 61A and 61B and the retainer 61C). With the low-speed disk 61 constituted by the two low-speed disks 61A and 61B, the low-speed disk 61A of them in contact with the inner seat portion 63 is configured as a slit disk with a pair of cutouts 61A1 provided on the outer peripheral edge thereof. The cutouts 61A1 correspond to the first orifice (the piston extension-side orifice). The low-speed valve 61 contributes to the characteristic in the low speed region.

The slit disk (the low-speed disk 61A) may be omitted depending on the vehicle specifications. Further, for example, a disk having a diameter equal to the low-speed valve 61 (the low-speed valves 61A and 61B) or a valve having a plate thickness different between the radially inner portion and the radially outer portion (for example, the space adjustment valve 42 in FIG. 7) may be disposed on the back surface (the lower surface) of the retainer 61C for the purpose of restricting the lift amount of the low-speed valve 61 (the low-speed disks 61A and 61B), although the illustration thereof is omitted.

As the damping force in the low speed region of the piston extension-side valve 6, it is useful to increase the contribution of the damping force generated by the low-speed valve 61. To achieve that, the disk 62A in contact with the outer seat portion 64, among the four disks 62A, 62B, 62C, and 62D forming the second-stage valve 62, is configured as a slit disk with a pair of cutouts 62A1 provided on the outer peripheral edge thereof. In this case, the contribution of the second-stage valve 62 to the generation of the damping force in the low speed region is reduced by securing a sufficient orifice area with the aid of the disk 62A (the slit disk).

The second-stage valve 62 plays a role of generating the damping force in the intermediate-to-high speed region of the piston extension-side valve 6. Therefore, the stiffness of the second-stage valves 62 is adjusted based on parameters such as the number of stacked disks 62A, 62B, 62C, and 62D, the plate thickness, and the radial dimension of the retainer 25 on the back surface side. Further or alternatively, the second-stage valve 62 may be adjusted so as to be able to acquire a desired characteristic by providing a set step to the second-stage valve 62 to apply a preload. The inner seat portion 63, which the low-speed valve 61 is seated on and separated from, is not limited to the annular seat shape and may have a seat shape having a different diameter depending on a characteristic desired to be acquired in the low speed region.

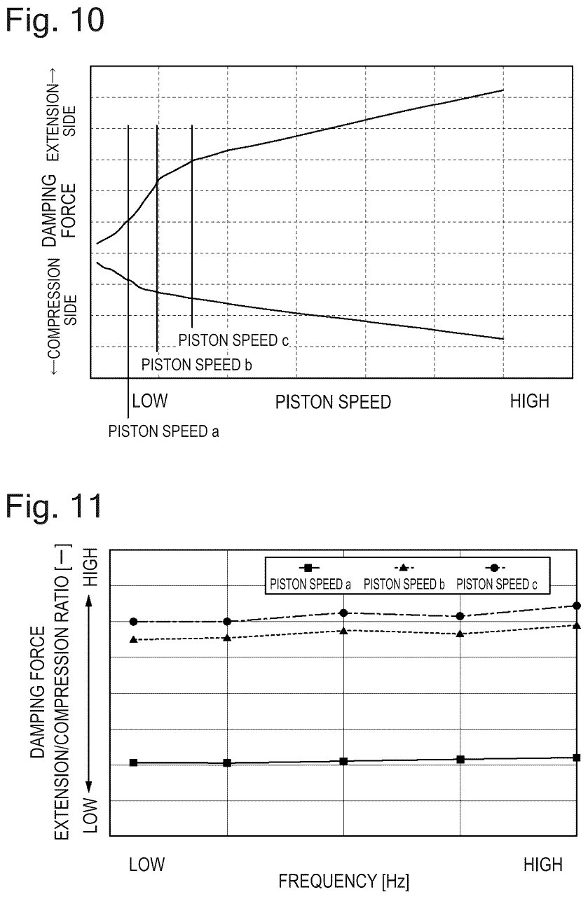

The second embodiment includes the low-speed valve 61 and the second-stage valve 62 as described above, and the basic operation thereof is not significantly different from the operation according to the above-described first embodiment. In other words, the second embodiment can also acquire such a damping force characteristic that the sprung side of the vehicle is stabilized regardless of the road surface, similarly to the first embodiment. FIG. 10 illustrates the characteristic of the damping force with respect to the piston speed according to the second embodiment. FIG. 11 illustrates changes in the extension/compression ratio of the damping force with respect to the frequency at the three different three piston speeds illustrated in FIG. 10 (the piston speed a, the piston speed b, and the piston speed c). As clearly seen from a comparison between FIG. 11 and the above-described drawing, FIG. 15, the provision of the valve-opening promotion mechanism 21 can considerably reduce the change in the extension/compression ratio of the damping force with respect to the frequency. As a result, the shock absorber 1 can realize ride comfort further robust against a change in the road surface condition and sufficient to give a sense of stability to the passenger feel compared with the configuration not including the valve-opening promotion mechanism 21 (the low-speed valve 61).

The valve-opening point of the valve cannot be precisely determined from the “damping force-piston speed line graph” like the examples illustrated in the above-described drawings, FIGS. 5 and 10. In other words, even though the point on the polygonal line of the extension-side damping force and the point on the polygonal line of the compression-side damping force look like as if they are in alignment with each other on the “damping force-piston speed line graph”, the valve-opening timings of the valves are not necessarily in alignment. For example, the valve-opening promotion mechanism 21 according to the first embodiment has such a characteristic that the valve stiffness is non-linearly set to be low only in the low speed region and high in the intermediate-to-high speed region, and therefore a clear valve-opening point of the valve does not appear on the damping force-piston speed line graph. Further, in the case of such a configuration that the low-speed valve 61 and the second-stage valve 62 are arranged in series like the second embodiment, the valve-opening point of the second-stage valve 62 set to a higher valve-opening pressure appears on the line graph, but the valve-opening point of the low-speed valve 61 does not clearly appear. Therefore, it is difficult to determine the valve-opening point of the valve on the “damping force-piston speed line graph”, and the valve-opening point of the valve should be identified by a calculation based on the orifice, the valve pressure-receiving area, and the valve stiffness or by a measurement of the frequency characteristic at each piston speed to determine the valve-opening point of the valve. In other words, the valve-opening timing of the valve (the piston speed) is determined based on the differential pressure applied to between flows upstream and downstream of the valve, the valve stiffness, the set load, the pressure-receiving area, and the shape of the valve seat, and therefore should be determined by a calculation instead of being spotted from the “damping force-piston speed line graph”.

The first embodiment has been described citing the example in which the piston extension-side valve 6 is assumed to be the first valve and the piston compression-side valve 7 is assumed to be the second valve. However, without being limited thereto, for example, the piston extension-side valve and the piston compression-side valve may be the second valve and the first valve, respectively. The same also applies to the second embodiment and the modification.

The first embodiment has been described citing the example in which the body extension-side valve 13 is assumed to be the third valve and the body compression-side valve 14 is assumed to be the fourth valve. However, without being limited thereto, for example, the body extension-side valve and the body compression-side valve may be the fourth valve and the third valve, respectively. The same also applies to the second embodiment and the modification.

The first embodiment has been described citing the example in which the shock absorber 1 is configured in such a manner that the piston extension-side valve 6 on the lower side of the piston 5 generates the damping force by applying the resisting force to the oil fluid (the hydraulic fluid) during the extension stroke of the piston rod 10, and the piston compression-side valve 7 on the upper side of the piston 5 generates the damping force by applying the resisting force to the oil fluid (the hydraulic fluid) during the compression stroke of the piston rod 10. However, without being limited thereto, the shock absorber 1 may be configured in such a manner that, for example, a check valve is used as the piston extension-side valve on the upper side of the piston, and the damping force is generated by the body compression-side valve serving as the fourth valve provided on the valve body during the compression stroke of the piston rod. The same also applies to the second embodiment and the modification.

The first embodiment has been described citing the example in which the shock absorber 1 is configured in such a manner that the piston extension-side valve 6, which is one of the piston extension-side valve 6 and the body compression-side valve 14 that is set to a higher valve-opening pressure, is provided with the valve-opening promotion mechanism 21 that aligns the valve-opening timing thereof with the valve-opening timing of the piston compression-side valve 7, which is the other of them that is set to a lower valve-opening pressure. However, without being limited thereto, for example, in a case where the body compression-side valve is the one of the piston extension-side valve and the body compression-side valve that is set to a higher valve-opening pressure, the body compression-side valve may be provided with the valve-opening promotion mechanism that aligns the valve-opening timing thereof with the valve-opening timing of the piston extension-side valve, which is the other of them that is set to a lower valve-opening pressure. The same also applies to the second embodiment and the modification.

The first embodiment has been described citing the double tube-type shock absorber 1 including the outer tube 2 and the inner tube 4 by way of example. However, without being limited thereto, the present invention may be applied to, for example, a shock absorber formed by a single tube-type tubular member (cylinder). In this case, the valve-opening promotion mechanism can be provided to the first valve or the second valve attached to the piston, whichever is set to a higher stiffness. The same also applies to the second embodiment and the modification.

Further, each of the embodiments and the modification have been described citing the shock absorber mounted on the automobile by way of example, as a representative example of shock absorbers. However, without being limited thereto, the present invention may be applied to, for example, a shock absorber mounted on a railway train. Alternatively, without being limited to vehicles such as an automobile and a railway train, the present invention can be applied to various kinds of shock absorbers used for, for example, various machines, structures, and buildings that become vibration sources.

Further, each of the embodiments and the modification are only an example, and it goes without saying that the configurations indicated in the different embodiments and modification can be partially replaced or combined.

According to the above-described embodiments and/or modification (hereinafter simply referred to as the “embodiments”), the first valve or the second valve, whichever is set to a higher valve-opening pressure, is provided with the valve-opening promotion mechanism that aligns the valve-opening timing thereof with the valve-opening timing of the other of them that is set to a lower valve-opening pressure. This makes it possible to raise the stiffness in the intermediate-to-high speed region while allowing the valve set to a higher valve-opening pressure to be opened at a further low piston speed. Due to that, the shock absorber can secure the damping force of the valve set to a higher valve-opening pressure in the intermediate-to-high speed region while reducing the frequency dependency of the extension/compression ratio of the damping force. As a result, the shock absorber can realize ride comfort further robust against a change in the road surface condition and sufficient to give a sense of stability to the passenger compared with the configuration not including the valve-opening promotion mechanism. In sum, the shock absorber can acquire such a damping force characteristic that the sprung side of the vehicle is stabilized regardless of the road surface, thereby allowing the passenger to continue riding on the vehicle without feeling uncomfortable.

According to the embodiments, the shock absorber is configured to cause the frequency characteristic of the first valve or the second valve, whichever corresponds to a damping force having a higher frequency dependency, to match the frequency characteristic of the valve corresponding to a damping force having a lower frequency dependency. Due to that, the shock absorber 1 can reduce the frequency dependency of the extension/compression ratio of the damping force. As a result, the shock absorber can realize ride comfort further robust against a change in the road surface condition and sufficient to give a sense of stability to the passenger. In sum, the shock absorber can acquire such a damping force characteristic that the sprung side of the vehicle is stabilized regardless of the road surface, thereby allowing the passenger to continue riding on the vehicle without feeling uncomfortable.

According to the embodiments, the first valve or the second valve, whichever is set to a higher valve-opening pressure, is opened when the piston speed is lower compared with the valve set to a lower valve-opening pressure. This makes it possible to raise the stiffness in the intermediate-to-high speed region while allowing the valve set to a higher valve-opening pressure to be opened at a further low piston speed. As a result, the shock absorber can secure the damping force of the valve set to a higher valve-opening pressure in the intermediate-to-high speed region while reducing the frequency dependency of the extension/compression ratio of the damping force.

According to the embodiments, the first valve or the second valve, whichever is set to a higher valve-opening pressure, is provided with the low-speed valve that is subjected to a weaker biasing force compared with the valve set to a lower valve-opening pressure and opens the first passage or the second passage when the piston speed is low. This makes it possible to raise the stiffness in the intermediate-to-high speed region while allowing the valve set to a higher valve-opening pressure to be opened at a further low piston speed. As a result, the shock absorber can reduce the frequency dependency of the extension/compression ratio of the damping force while ensuring the flexibility of the damping force of the valve set to a higher valve-opening pressure in the intermediate-to-high speed region.

According to the embodiments, the space is defined between the “low-speed valve” and the “valve staked on the low-speed valve”. This makes the low-speed valve easily displaceable (deformable) to the space side. As a result, the low-speed valve can be opened when the piston speed is low.

According to the embodiments, the low-speed valve includes the fifth valve having the protrusion portion protruding toward the second valve and axially wider than the other portions, and the small-diameter disk between the second valve and the fifth valve. This makes it possible to narrow the space between the second valve and the fifth valve (the protrusion portion) while increasing the plate thickness of the small-diameter disk. As a result, the shock absorber can both “ensure the mass productivity and the strength of the small-diameter disk” and “ensure the flexibility of the adjustment of the damping force” at the same time.

According to the embodiments, the first valve or the fourth valve, whichever is set to a higher valve-opening pressure, is provided with the valve-opening promotion mechanism that aligns the valve-opening timing thereof with the valve-opening timing of the valve set to a lower valve-opening pressure. This makes it possible to raise the stiffness in the intermediate-to-high speed region while allowing the valve set to a higher valve-opening pressure to be opened at a further low piston speed. Due to that, the shock absorber can secure the damping force of the valve set to a higher valve-opening pressure in the intermediate-to-high speed region while reducing the frequency dependency of the extension/compression ratio of the damping force. As a result, the shock absorber can realize ride comfort further robust against a change in the road surface condition and sufficient to give a sense of stability to the passenger compared with the configuration not including the valve-opening promotion mechanism. In sum, the shock absorber can acquire such a damping force characteristic that the sprung side of the vehicle is stabilized regardless of the road surface, thereby allowing the passenger to continue riding on the vehicle without feeling uncomfortable.

The present application claims priority under the Paris Convention to Japanese Patent Application No. 2022-156052 filed on Sep. 29, 2022. The entire disclosure of Japanese Patent Application No. 2022-156052 filed on Sep. 29, 2022 including the specification, the claims, the drawings, and the abstract is incorporated herein by reference in its entirety.

### REFERENCE SIGNS LIST

1 shock absorber
2 outer tube
4 inner tube
5 piston
5A first oil passage (first passage)
5B second oil passage (second passage)
6 piston extension-side valve (first valve)
7 piston compression-side valve (second valve)
12 valve body
12A third oil passage (third passage)
12B fourth oil passage (fourth passage)
13 body extension-side valve (third valve)
14 body compression-side valve (fourth valve)
21 valve-opening promotion mechanism
22, 41, 61 low-speed valve
22B small-diameter disk
42 space adjustment disk (fifth valve)
42A protrusion portion
52 piston extension-side orifice (first orifice)
57 body compression-side orifice (second orifice)
A reservoir chamber
B rod-side oil chamber (first chamber)
C bottom-side oil chamber (second chamber)

1. A shock absorber comprising:
an inner tube sealingly containing hydraulic fluid therein;
a piston slidably provided in the inner tube and partitioning an inside of the inner tube into a first chamber and a second chamber;
a first passage provided on the piston;
a first valve configured to open and close the first passage;
a second passage provided on the piston; and
a second valve configured to open and close the second passage,
wherein the first valve or the second valve, whichever is set to a higher valve-opening pressure, is provided with a valve-opening promotion mechanism configured to align a valve-opening timing thereof with a valve-opening timing of the other of them that is set to a lower valve-opening pressure.

2. A shock absorber comprising:
an inner tube sealingly containing hydraulic fluid therein;
a piston slidably provided in the inner tube and partitioning an inside of the inner tube into a first chamber and a second chamber;
a first passage provided on the piston;
a first valve configured to open and close the first passage;
a second passage provided on the piston; and
a second valve configured to open and close the second passage,
wherein the shock absorber is configured to cause a frequency characteristic of the first valve or the second valve, whichever corresponds to a damping force having a higher frequency dependency, to match a frequency characteristic of the other of them that corresponds to a damping force having a lower frequency dependency.

3. The shock absorber according to claim 1, wherein the first valve or the second valve, whichever is set to the higher valve-opening pressure, is opened when a piston speed is lower compared with the other of them that is set to the lower valve-opening pressure.

4. A shock absorber comprising:
an inner tube sealingly containing hydraulic fluid therein;
a piston slidably provided in the inner tube and partitioning an inside of the inner tube into a first chamber and a second chamber;
a first passage provided on the piston;
a first valve configured to open and close the first passage;
a second passage provided on the piston; and
a second valve configured to open and close the second passage;
wherein the first valve or the second valve, whichever is set to a higher valve-opening pressure, is provided with a low-speed valve subjected to a weaker biasing force compared with the other of them that is set to a lower valve-opening pressure and configured to open the first passage or the second passage when a piston speed is low.

5. The shock absorber according to claim 4, wherein a space is defined between the low-speed valve and a valve stacked on the low-speed valve.

6. The shock absorber according to claim 4, wherein the low-speed valve includes a fifth valve having a protrusion portion protruding toward the second valve and axially wider than other portions, and a small-diameter disk disposed between the second valve and the fifth valve and smaller in diameter than the second valve and the fifth valve.

7. A shock absorber comprising:
an inner tube sealingly containing hydraulic fluid therein;
a piston slidably provided in the inner tube and partitioning an inside of the inner tube into a first chamber and a second chamber;
an outer tube provided outside the inner tube and defining a reservoir chamber between the outer tube and the inner tube;
a valve body provided between the reservoir chamber and the second chamber;
a first passage provided on the piston;
a first valve configured to open and close the first passage;
a first orifice provided to the first passage;
a second passage provided on the piston;
a second valve configured to open and close the second passage;
a third passage provided on the valve body;
a third valve configured to open and close the third passage;
a fourth passage provided on the valve body;
a fourth valve configured to open and close the fourth passage; and
a second orifice provided to the fourth passage,
wherein the first valve or the fourth valve, whichever is set to a higher valve-opening pressure, is provided with a valve-opening promotion mechanism configured to align a valve-opening timing thereof with a valve-opening timing of the other of them that is set to a lower valve-opening pressure.
